(19) United States
(12) Patent Application Publication
(10) Pub. No.: US 2024/0260560 A1
(43) Pub. Date: Aug. 8, 2024

(54) METHOD AND SYSTEM FOR CONTROLLING PESTICIDES SPRAY IN A FIELD

(71) Applicant: Edward H Tradup, Brewster, WA (US)

(72) Inventor: Edward H Tradup, Brewster, WA (US)

(21) Appl. No.: 18/105,450

(22) Filed: Feb. 3, 2023

(51) Int. Cl. A01M 1/20

(52) U.S. Cl. CPC A01M 1/2033

(57) ABSTRACT

The present disclosure discloses a pest control system that is designed to blow the overspray of pesticides away from the traffic. The steps for the process include positioning the fan trailer appropriately on a spot, powering the fan that will blow overspray back toward trees, spraying the trees, and then moving the trailer to the next spot. This will blow the overspray away from the traffic and prevent spraying passing vehicles and passengers.

### TECHNICAL FIELD

The present invention relates to the field of the control system. More particularly, the present invention relates to a pest control system that is designed to blow the overspray of pesticides away from the traffic.

### INTRODUCTION

During pesticide spraying of fruit trees or farm fields, there is often an overspray of pesticides that drifts with the wind. When the orchard is around a road, the sprayer may have to wait until all traffic has passed to avoid spraying passing vehicles and passengers therein. This often involves having a flagger present near the road at the time of spraying the pesticides to stop traffic or signal to the sprayer that it must wait. For example, in FIG. 1, the diagram shows an illustration of a similar case. As shown, a flagger 106 is standing near road 102 around which fields 104 are getting sprayed by a sprayer 112. The sprayer 112 may be out there for spraying the pesticides to the fields 104 by using a spraying device 110 as shown. Further, when the flagger sees any passing vehicle such as a car 108 on the road 102, the flagger 106 may have to indicate either the sprayer 112 to stop spraying or ask the driver of the car 108 to stop. The cost of running a sprayer is quite high, so the idle time waiting for traffic to pass amounts to a significant expense. Likewise, the cost of a flagger can add to the expense. Thus, there is a need for a system that can overcome the existing problems. The present invention discloses a system that is designed to blow overspray away from the traffic.

### SUMMARY

The present invention discloses a method and system to blow away overspray of pesticides from traffic when an individual is spraying pesticides over plants in a farm. The farm may be located along a roadside or pathway that is used for travelling by the people. The system includes a power generator and a fan mounted on a trailer. The power generator may be used for powering the fan. The trailer may be moved from position to another position. The steps for the process include positioning the fan trailer appropriately on a spot, powering the fan that will blow overspray back toward trees, spraying the trees, and then moving the trailer to the next spot. This will blow the overspray away from the traffic and prevent spraying passing vehicles and passengers. This will further ensure that there is no idle time for the individual who is designated for spraying the fields with pesticides. Furthermore, the cost of having a flagger to manage the traffic may be reduced. Furthermore, the wastage of pesticides may be reduced. These and other features and advantages of the present invention will become apparent from the detailed description below, considering the accompanying drawings.

### BRIEF DESCRIPTION OF THE DRAWINGS

Having thus described the invention in general terms, reference will now be made to the accompanying drawings, which are not necessarily drawn to scale, and wherein:

FIG. 1 is a diagram that illustrates a traditional system environment for spraying pesticides over trees/plants in a field located along a roadside, in accordance with various embodiments of the present disclosure.

FIG. 2 is a diagram that illustrates a blower system to blow the overspray of pesticides away from the traffic, in accordance with various embodiments of the present disclosure.

FIG. 3 is a diagram that illustrates usage of the blower system along a field spot during pesticide spraying, in accordance with various embodiments of the present disclosure.

FIG. 4 is a diagram that illustrates the blower system attached to a vehicle for use along various field spots, in accordance with various embodiments of the present disclosure.

FIG. 5 is a diagram illustrating an arrangement of the blower system in an orchard or farm, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Reference will now be made in detail to selected embodiments of the present disclosure in conjunction with accompanying figures. Among various embodiments, the disclosed control system has been designed to blow the overspray of pesticides away from the traffic. The embodiments' described figures are intended and provided to illustrate embodiments of the disclosure described below and are not necessarily drawn to scale. In the drawings, like numbers refer to like elements throughout, and the thicknesses and dimensions of some components may be exaggerated for providing better clarity and ease of understanding. Further, the terms “a” and “an” herein do not denote a limitation of quantity, but rather denote the presence of at least one of the referenced items.

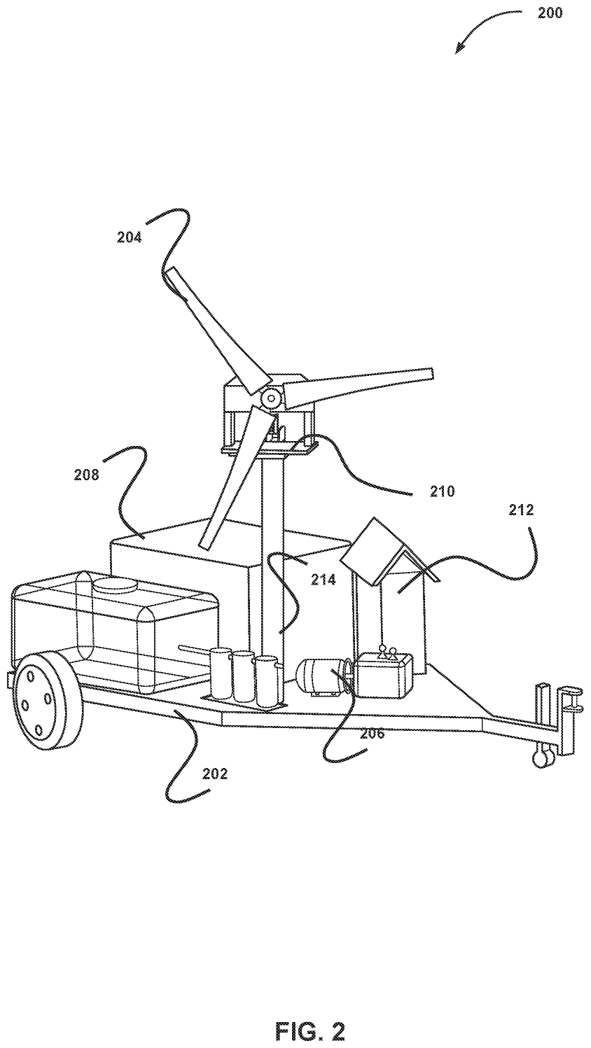

FIG. 2 is a diagram that illustrates a blower system 200 to blow the overspray of pesticides away from the traffic, in accordance with various embodiments of the present disclosure.

The blower system 200 includes a platform or trailer 202 for installing a fan 204, a motor 206, a generator 208, a crank rocker mechanism 210, and a control system 212. The fan 204 is a large fan (e.g., an orchard fan) that is mounted on the platform or trailer 202 in a vertical manner such that it can swivel around the crank rocker mechanism 210. This helps in controlling the direction of fan air. The fan 204 is used to circulate air over the orchards to protect from frost. The fan 204 is driven by a drive shaft that goes up through its tower 214 and uses two right angle gearboxes.

The fan motor 206 is very simple in construction. The fan motor 206 consists of a synchronous or asynchronous electric motor, with a fan wheel of the associated shaft, and the connections for the lines. The fan motor 206 consists of a stator and contains a rotating rotor inside, which is surrounded by pole-pieces. The types and sizes of the fan motor 206 are very different and differentiate heavily among themselves. The reason for this is the area and the performance of the engines. The higher the performance, the more complex the structure needs to be.

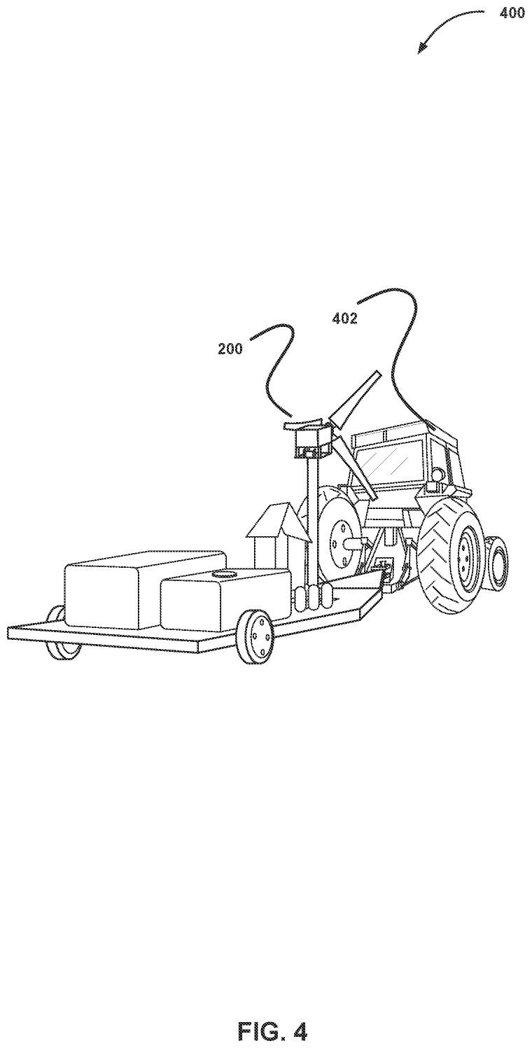

The generator 208 is a power source installed on the platform or trailer 202 for powering the fan 204 and other devices as and when required during the process. The fan 204 may also be powered either by a motor that is mounted to the platform or trailer 202, or it could be designed to be towed behind a tractor (as shown in FIG. 4) and to run off the Power Take Off (PTO) rather than having a separate motor to run the fan. The fan and motor must be sized large enough to be effective in countering any breeze that would cause overspray to drift into traffic.

The control system 212 is configured to control speed of the fan 204 and direction of operation of the fan 204. The control system 212 may include an interactive interface that can be used by an individual to operate the fan operation and control the fan speed and direction when the fan 204 is being used to blow the overspray of pesticides away from the traffic. The fan 204 creates or produces a flow of air that blows overspray of the pesticides back toward the trees and/or plants, thereby blowing away the overspray of pesticides away from traffic along the roadside.

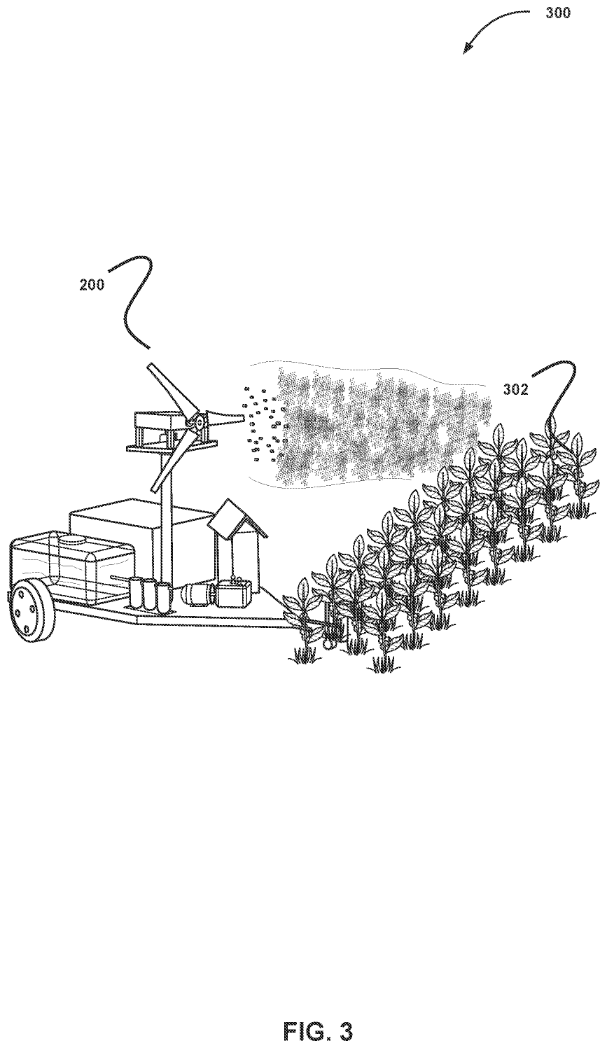

FIG. 3 is a diagram 300 that illustrates the usage of the blower system 200 along a field spot during pesticide spraying on a farm field 302 of tress and/or plants, in accordance with various embodiments of the present disclosure.

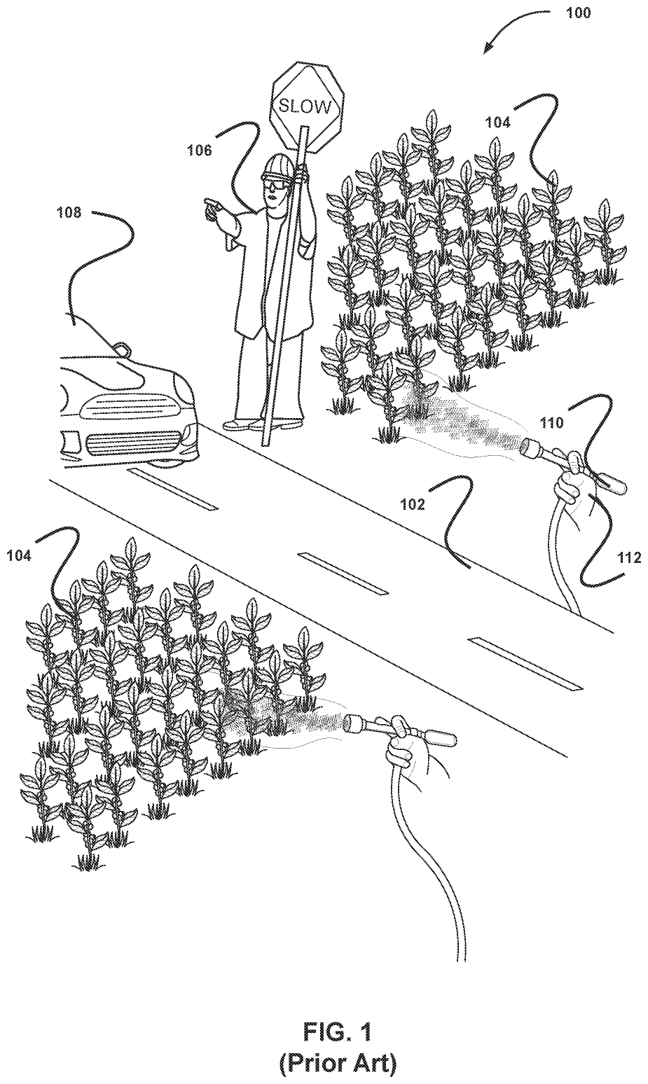

The farm field 302 may be located along a roadside or pathway that is used for travelling by the people. The blower system 200 may be placed at one spot along the roadside. The generator 208 (in FIG. 1) is turned ON for powering the fan 204 of the blower system 200. The fan 204 may be driven by a drive shaft that goes up through its tower 214 and uses two right angle gearboxes. The trailer or platform 202 may be moved from one position to another position along the roadside. The sprayer (an individual who is responsible for spraying pesticides) may spray pesticides on tress and/or plants of the farm field 302.

The steps for the process include positioning the fan trailer 202 appropriately on a spot along the roadside, powering the fan 204 that will blow overspray of pesticides back toward the trees and/or plants, spraying the trees and/or plants again, and then moving the trailer to the next spot along to the roadside. This will blow the overspray away from the traffic and prevent spraying passing vehicles and passengers. This will further ensure that there is no idle time for the individual who is designated for spraying the fields with pesticides. Furthermore, the cost of having a flagger to manage the traffic may be reduced. Furthermore, the wastage of pesticides may be reduced.

FIG. 4 is a diagram illustrating the blower system 200 attached to a vehicle 402 for use along various field spots. The vehicle 402 (e.g., a tractor) may be used to move the fan trailer 202 from one spot to another spot when the sprayer is spraying pesticides on tress and/or plants of the farm field 302.

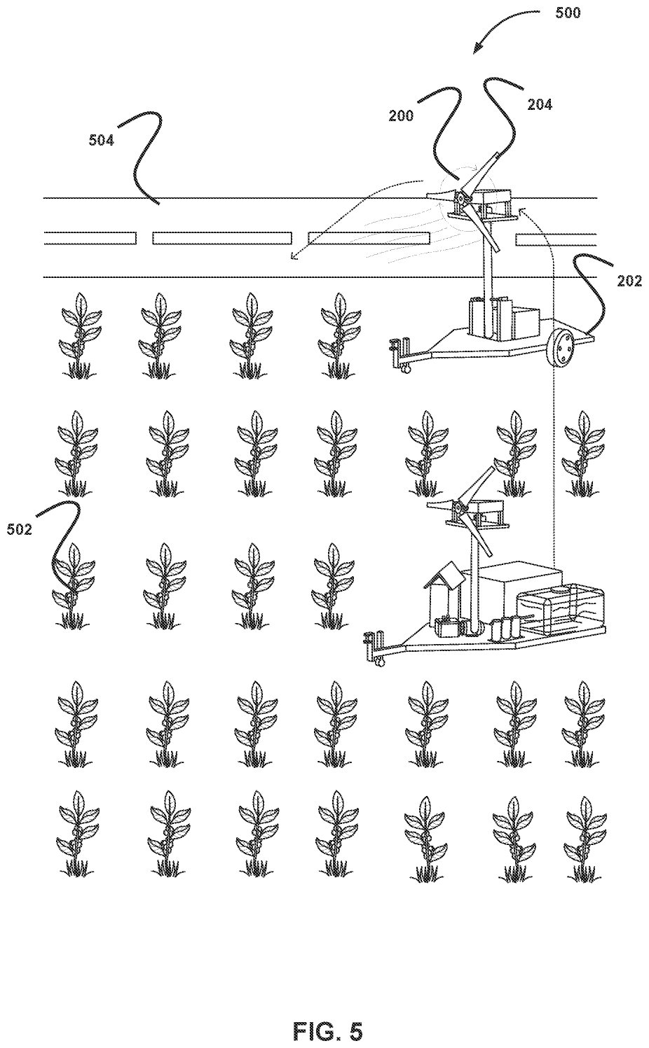

FIG. 5 is a diagram illustrating an arrangement of the blower system 200 including the fan 204 mounted on the trailer 202 in an orchard or farm 502. The blower system 200 blows away overspray of pesticides from the traffic when an individual is spraying pesticides over plants in the farm 502. The farm may be located along a roadside or pathway 504 that is used for travelling by the people. The blower system 200 includes the power generator (shown in FIG. 2) and the fan 204 mounted on the trailer 202. The power generator may be used for powering the fan. The fan 204 is driven by the drive shaft that goes up through its tower and uses two right angle gearboxes. The trailer 202 may be moved from one position to another position. The steps for the process include positioning the one or more fan trailers 202 appropriately on one or more spots (as shown in FIG. 5), powering the one or more fans 204 that will blow overspray back toward trees, spraying the trees, and then moving the one or more trailers 202 to the next spots. This will blow the overspray away from the traffic and prevent spraying passing vehicles and passengers.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

1. A system, comprising:
a fan mounted on a trailer, and
a generator mounted on the trailer
wherein the trailer including the fan and generator is positioned at a spot along a roadside,
wherein the roadside is surrounded by a farm including plants and/or trees,
wherein the fan is powered by the generator when an individual is spraying pesticides on the plants and/or trees, and
wherein the fan creates a flow of air that blows overspray of the pesticides back toward the trees and/or plants, thereby blowing away the overspray of pesticides away from traffic along the roadside.

2. The system of claim 1, wherein the fan is an orchard fan used to circulate air over its orchards to protect from frost.

3. The system of claim 1, further comprising a control system for controlling speed of the fan and direction of operation of the fan.

4. The system of claim 1, wherein the fan is also powered either by a motor that is mounted to the trailer.

5. The system of claim 1, wherein the fan is designed to be towed behind a tractor and to run off a Power Take Off (PTO) rather than having a separate motor to run the fan.

6. The system of claim 1, wherein the fan is mounted on the trailer in a vertical manner such that it can swivel around a crank rocker mechanism which helps in controlling the direction of fan air.

7. The system of claim 1, wherein the fan is driven by a drive shaft that goes up through its tower and uses two right angle gearboxes.
